(19) United States
(12) Patent Application Publication
(10) Pub. No.: US 2009/0164659 A1
(43) Pub. Date: Jun. 25, 2009

(54) COMMUNICATION SYSTEM ALLOWING REDUCTION IN CONGESTION BY RESTRICTING COMMUNICATION

(75) Inventor: Yoshihiko HOSHINO, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/341,018

(22) Filed: Dec. 22, 2008

(30) Foreign Application Priority Data
Dec. 25, 2007 (JP) 2007-331932

(51) Int. Cl. G06F 15/16

(52) U.S. Cl. 709/235

(57) ABSTRACT

A signal processing server apparatus compares a predetermined threshold value with the usage rate of a processor which processes a signal in Internet Protocol communication, determines, based on the comparison result, whether or not congestion has occurred, and gives an instruction to restrict the communication during occurrence of congestion. An opposed station apparatus restricts Internet Protocol communication with the signal processing server apparatus according to the instruction from the signal processing server apparatus.

This application is based upon and claims the benefit of priority from Japanese Patent Application No. 2007-331932 filed on Dec. 25, 2007, the content of which is incorporated by reference.

### BACKGROUND OF THE INVENTION

1. Field of the Invention

The present invention relates to a signal processing server apparatus in an IP (Internet Protocol) network, and more particularly to a technique of controlling congestion thereof.

2. Description of the Related Art

For networks based on circuit switching, there has been disclosed a technique of measuring, as congestion data, the usage rate of the CPU (Central Processing Unit) that performs call processings in switching equipment, the usage rate of the control buffer, the number of busy calls per subscriber, and the like and imposing restriction on communications according to these measured values (refer to Japanese Patent Laid-Open No. 5-22407).

Further, according to Japanese Patent Laid-Open No. 5-22407, the degree of restriction varies according to the congestion data, so that congestion is effectively controlled.

For common line signal networks, there has been disclosed a technique by which the number of signals from higher level users is measured by switching equipment and when the signal network is congested, restriction is imposed on each higher level user according to the measured value (refer to Japanese Patent Laid-Open No. 5-252262).

Meanwhile, in many IP networks, particularly in relatively simple systems such as WiMAX (Worldwide Interoperability for Microwave Access), when the signal processing server receives so many signals that the processing capacity is exceeded, congestion control which discards those signals is supposed to be performed. According to this technique, congestion control is implemented by a simple operation.

With such control technique, however, it is likely that congestion will not be effectively controlled and thus the congestion state will hardly reduced. For example, when the authentication server receives too many authentication session requests, it is likely that the discarding of signals increases the number of authentications, which do not terminate properly, and thus the session requests are repeated, so that the congestion further deteriorates. In a worst case, a system down may occur.

### SUMMARY OF THE INVENTION

An exemplary object of the invention is to provide a technique of effectively executing congestion control for a signal processing server in an IP network by using a simple operation.

To achieve the above object, a communication system according to an exemplary aspect of the invention includes: a signal processing server apparatus that compares a predetermined threshold value with the usage rate of a processor which processes a signal in Internet Protocol communication, and which determines, based on the comparison result whether or not congestion has occurred, and gives an instruction for restricting the communication during occurrence of congestion; and an opposed station apparatus that restricts Internet Protocol communication with the signal processing server apparatus according to the instruction from the signal processing server apparatus.

According to an exemplary aspect of the invention, there is provided a communication restriction method for a signal processing server apparatus that communicates with an opposed station apparatus through Internet Protocol and processes a signal received from the opposed station apparatus, the method including: measuring the usage rate of a processor that processes the signal; determining whether or not congestion has occurred, based on a result of comparing the usage rate of the processor with a predetermined threshold value; and giving an instruction to restrict communication to the opposed station apparatus during occurrence of congestion.

According to an exemplary aspect of the invention, there is provided a signal processing server apparatus that communicates with an opposed station apparatus through Internet Protocol and processes a signal received from the opposed station apparatus, the apparatus including: a processor that processes the signal; usage rate measurement means for measuring the usage rate of the processor; congestion determination means for determining whether or not congestion has occurred, based on a result of comparing the usage rate of the processor with a predetermined threshold value; and restriction instruction means for, when the congestion determination means determines that congestion has occurred, giving an instruction to the opposed station apparatus for restricting the communication.

The above and other objects, features, and advantages of the present invention will become apparent from the following description with references to the accompanying drawings which illustrate examples of the present invention.

### BRIEF DESCRIPTION OF THE DRAWINGS

FIG. 1 is a block diagram illustrating a configuration of an IP communication system according to an exemplary embodiment;

FIG. 2 is a sequence chart illustrating the operation of the IP communication system according to the present exemplary embodiment;

FIG. 3 is a block diagram illustrating a configuration of a signal processing server apparatus according to the present exemplary embodiment;

FIG. 4 is a flowchart illustrating the operation of the signal processing server apparatus according to the present exemplary embodiment;

FIG. 5 is an example of a table which associates the restriction level with the threshold value;

FIG. 6 is a view illustrating an exemplary operation of signal processing server apparatus 11 according to an example at the time that congestion occurs; and

FIG. 7 is a view illustrating an exemplary operation of signal processing server apparatus 11 according to the present example at the time when congestion is dissolved.

### DETAILED DESCRIPTION OF THE PREFERRED EMBODIMENTS:

An exemplary embodiment will be described with reference to the drawings.

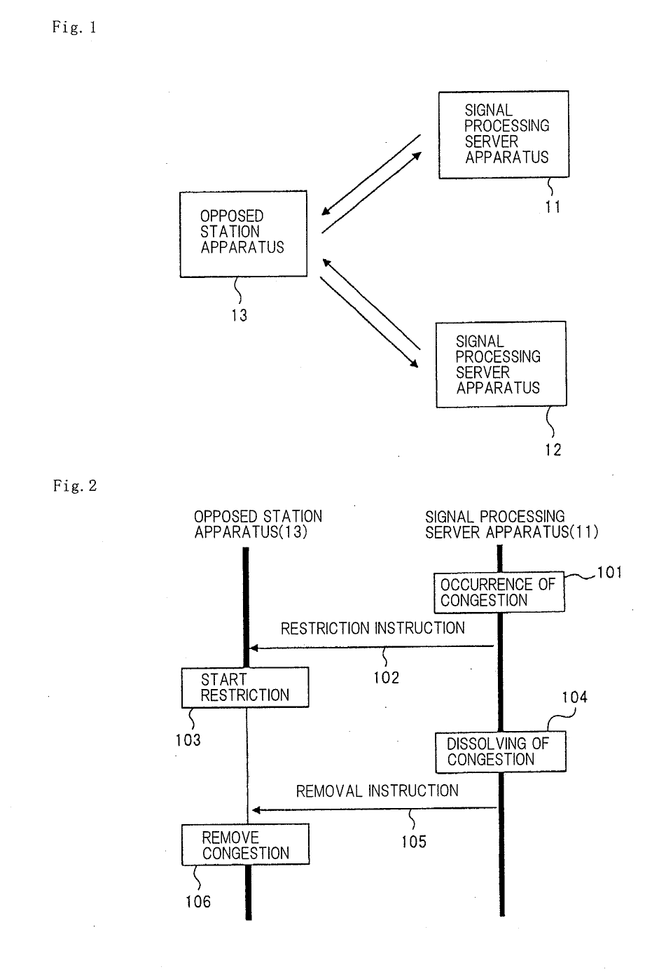

FIG. 1 is a block diagram illustrating a configuration of an IP communication system according to the present exemplary embodiment. Referring to FIG. 1, the IP communication system according to the present exemplary embodiment includes signal processing server apparatuses 11 and 12, and opposed station apparatus 13.

Signal processing server apparatuses 11 and 12 are apparatuses which perform IP communication with opposed station apparatus 13 and which process a received signal. An example of a signal processing server apparatus includes an authentication server which receives an authentication request from opposed station apparatus 13 and which executes authentication processing for opposed station apparatus 13. More specifically, signal processing server apparatuses 11 and 12 may be Radius (Remote Authentication Dial In User Service) servers which provide AAA (Authorization, Authentication, Accounting) service.

Opposed station apparatus 13 is a communication apparatus which performs IP communication and which communicates with signal processing server apparatuses 11 and 12. Only one opposed station apparatus 13 is illustrated in FIG. 1 but actually, multiple opposed station apparatuses 13 use signal processing server apparatuses 11 and 12 in a sharing manner. Accordingly, when signal processing server apparatuses 11 and 12 receive too many signals from multiple opposed station apparatuses 13, there may occur congestion in signal processing server apparatuses 11 and 12.

Signal processing server apparatuses 11 and 12 determine the occurrence of congestion based on the usage rate of a processor such as a CPU (Central Processing Unit) which processes a signal from opposed station apparatus 13. In IP communication signal processings, the usage rate of the processor which processes signals corresponds exactly to the congestion state, so the congestion state can be properly determined by using the usage rate of the processor. When congestion occurs, signal processing server apparatuses 11 and 12 give an instruction to restrict communication to opposed station apparatus 13. Then, opposed station apparatus 13 restricts the communication according to the instruction from signal processing server apparatuses 11 and 12.

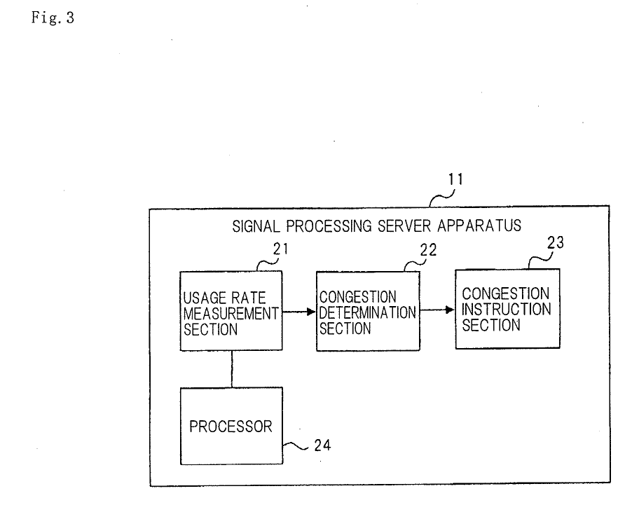

FIG. 2 is a sequence chart illustrating the operation of the IP communication system according to the present exemplary embodiment. FIG. 2 illustrates the operation at the time that congestion occurs in signal processing server apparatus 11. A threshold value used to determine the occurrence of congestion is preliminarily set and prestored in signal processing server apparatus 11.

Signal processing server apparatus 11 periodically measures the usage rate of the processor which processes a signal from opposed station apparatus 13, and compares the measured value with the threshold value. When the usage rate of the processor exceeds the threshold value, signal processing server apparatus 11 determines that congestion has occurred (step 101), and gives instructions to opposed station apparatus 13 to restrict the communication (step 102).

When receiving instructions for restricting the communication from the signal processing server apparatus, opposed station apparatus 13 restricts communication with the signal processing server apparatus (step 103). As a result of this restriction, the usage rate of the processor in signal processing server apparatus 11 gradually lowers.

When signal processing server apparatus 11 determines based on the comparison between the usage rate of the processor and the threshold value that congestion has dissolved, signal processing server apparatus 11 gives an instruction to opposed station apparatus 13 to remove the restriction (step 104). When receiving instruction for removing the restriction from signal processing server apparatus 11, opposed station apparatus 13 removes the restriction on communication with the signal processing server apparatus (step 105).

As an example of communication restriction, opposed station apparatus 13 may stop signal transmission to the signal processing server apparatus. Alternatively, opposed station apparatus 13 may send a signal not to the signal processing server apparatus which has given the instructions for restricting the communication, but to another signal processing server apparatus in a bypassing manner. More specifically, in a case where signal processing server apparatuses 11 and 12 are authentication servers, opposed station apparatus 13 may send, upon receipt of instructions for restricting the communication from one authentication server, an authentication session request to the other authentication server.

As described above, according to the present exemplary embodiment, signal processing server apparatuses 11 and 12 determine the occurrence of congestion based on the result of a comparison between the usage rate of the processor and the threshold value, and impose a restriction on communication with opposed station apparatus 13 when congestion occurs. Opposed station apparatus 13 restricts communication with signal processing server apparatuses 11 and 12 according to the instruction from signal processing server apparatuses 11 and 12. Consequently, according to the present exemplary embodiment, it is possible to effectively control congestion by a simple operation of comparing the usage rate of the processor and the threshold value. The operation for reducing congestion can be started before the signal quantity exceeds the processing capacity of the signal processing server apparatus.

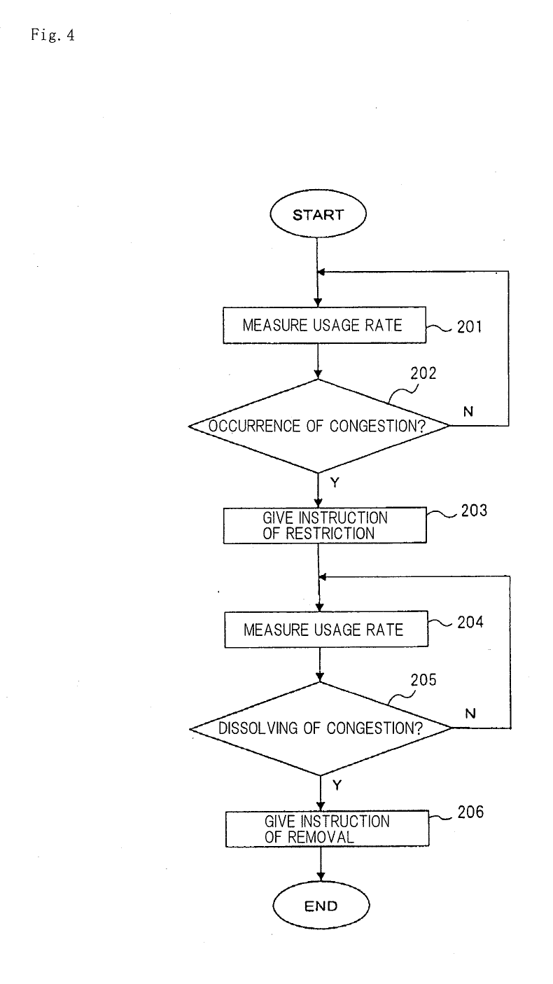

FIG. 3 is a block diagram illustrating a configuration of the signal processing server apparatus according to the present exemplary embodiment. Referring to FIG. 3, signal processing server apparatus 11 includes usage rate measurement section 21, congestion determination section 22, restriction instruction section 23 and processor 24. Here, signal processing server apparatus 12 has the same configuration as signal processing server apparatus 11.

Processor 24 is a processor that processes a signal from opposed station apparatus 13.

Usage rate measurement section 21 periodically measures the usage rate of processor 24.

Congestion determination section 22 determines the occurrence or dissolving of congestion based on the measurement result of usage rate measurement section 21. For example, congestion determination section 22 may compare the measured usage rate with a threshold value and, when the usage rate exceeds the threshold value, determines that congestion has occurred; and when the usage rate falls below the threshold value, congestion determination section 22 determines that congestion was dissolved.

When congestion determination section 22 determines that congestion has occurred, restriction instruction section 23 gives an instruction to opposed station apparatus 13 to restrict signal transmission. For example, upon occurrence of congestion, restriction instruction section 23 may initiate transmission of a restriction instruction signal (restriction state reporting signal) to opposed station apparatus 13; upon dissolving of the congestion, restriction instruction section 23 may stop the transmission of the restriction state reporting signal.

FIG. 4 is a flowchart illustrating the operation of the signal processing server apparatus according to the present exemplary embodiment. Referring to FIG. 4, signal processing server apparatus 11 measures the usage rate of processor 24 (step 201). Subsequently, signal processing server apparatus 11 compares the usage rate of the processor with the threshold value and thereby determines whether or not congestion has occurred (step 202). If it is determined that congestion has not occurred, signal processing server apparatus 11 returns to step 201, where periodic measurement of the usage rate is repeated.

If it is determined that congestion has occurred, signal processing server apparatus 11 gives an instruction to opposed station apparatus 13 to restrict the communication (step 203).

Thereafter, again, signal processing server apparatus 11 performs periodical measurement of the usage rate (step 204). Signal processing server apparatus 11 compares the usage rate of processor 24 with the threshold value and thereby determines whether or not congestion has dissolved (step 205). If it is determined that the congestion has not dissolved, signal processing server apparatus 11 returns to step 204, where periodical measurement of the usage rate is repeated.

If it is determined that the congestion has dissolved, signal processing server apparatus 11 gives instructions to opposed station apparatus 13 to remove the restriction (step 206).

According to the above described exemplary embodiment, the occurrence of congestion is determined based on whether or not the usage rate of the processor exceeds the threshold value. However, the present invention is not limited thereto. For example, the occurrence of congestion may be determined based on whether or not the usage rate of the processor continues to exceed the threshold value for a given time period or longer. In this case, it is possible to prevent the communication restriction control from being frequently performed in quick response to instantaneous fluctuations in the usage rate of the processor. Also, the threshold value may have a hysteresis characteristic, so that the control is prevented from becoming unstable.

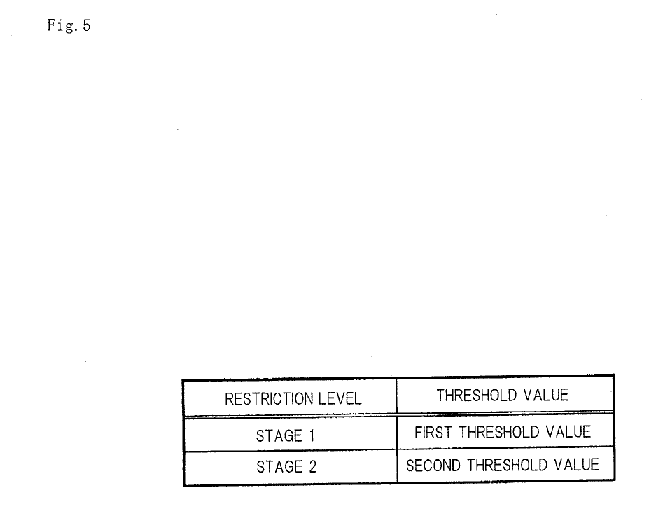

Also, multiple levels of restriction may be defined, so that stepwise restriction is implemented. For example, two levels of restriction may be defined: restriction stage 1 being relatively loose and restriction stage 2 being tighter. A threshold value is set for each of stage 1 and stage 2. The threshold value (second threshold value) of stage 2 is set higher than the threshold value (first threshold value) of stage 1. FIG. 5 is an example of a table which associates the restriction level with the threshold value. Congestion determination section 22 may consult the table and thereby determine that congestion has occurred.

When the usage rate of the processor exceeds the first threshold value, the loose restriction of stage 1 is imposed; and when the usage rate further rises and exceeds the second threshold value, the tighter restriction of stage 2 is imposed. However, in a state in which the restriction of stage 2 is imposed, when the usage rate of the processor falls below the second threshold value, the restriction of stage 2 is removed and the restriction of stage 1 is imposed. When the usage rate further lowers and falls below the first threshold value, the restriction of stage 1 is also removed. In this way, stepwise restriction and removal are implemented.

There will be described an example in which signal processing server apparatuses 11 and 12 act as a Radius server which executes AAA service. Signal processing server apparatuses 11 and 12 acting as a Radius server execute authentication processing in response to a request from opposed station apparatus 13. Here, assume that the execution of software program by processor 24 or another processor implements usage rate measurement section 21, congestion determination section 22 and restriction instruction section 23 in signal processing server apparatus 11.

Here, assume that two levels of restriction, i.e., STAGE 1 and STAGE 2 are defined. STAGE 1 restriction is for prohibiting a request for new authentication session. STAGE 2 restriction is for prohibiting transmission of all messages.

Here, as a threshold value at which STAGE 1 restriction starts, W % is set for the usage rate of CPU, and as a threshold value at which STAGE 2 restriction starts, X % is set for the usage rate of CPU.

Here, as a threshold value at which STAGE 1 restriction is removed, Z % is set for the usage rate of CPU, and as a threshold value at which STAGE 2 restriction is removed, Y % is set for the usage rate of CPU.

X is greater than W, and Y is greater than Z.

W may be equal to Z, but when Z is set smaller than W, a hysteresis characteristic is implemented. In this example, Z is set smaller than W. The relationship between X and Y is similar to the relationship between W and X. In this example, Y is set smaller than X.

All in all, X, Y, W and Z are in descending order.

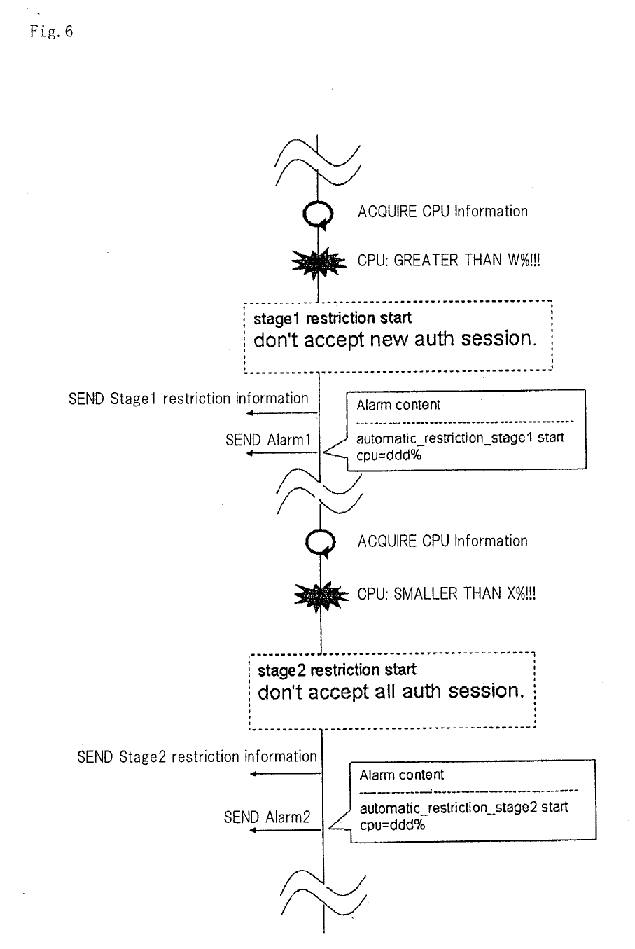

FIG. 6 is a view illustrating an exemplary operation of signal processing server apparatus 11 according to the present example at the time when congestion occurs.

Signal processing server apparatus 11 periodically acquires the CPU usage rate through a process in AAA. When the CPU usage rate exceeds W %, signal processing server apparatus 11 initiates STAGE 1 restriction.

In STAGE 1 restriction, signal processing server apparatus 11 sends to opposed station apparatus 13, a STAGE 1 restriction state reporting signal (“Stage1 restriction information” in FIG. 6) for prohibiting transmission of a new authentication session request, for example. Simultaneously, signal processing server apparatus 11 provides the maintenance person with an alarm (“Alarm1” in FIG. 6) indicating the occurrence of a STAGE 1 restriction state.

When the CPU usage rate further rises and exceeds X %, signal processing server apparatus 11 initiates STAGE 2 restriction. In STAGE 2 restriction, signal processing server apparatus 11 sends to opposed station apparatus 13, a STAGE 2 restriction state reporting signal (“Stage2 restriction information” in FIG. 6) for prohibiting transmission of all messages, for example. Simultaneously, signal processing server apparatus 11 provides the maintenance person with an alarm (“Alarm2” in FIG. 6) indicating the occurrence of a STAGE 2 restriction state.

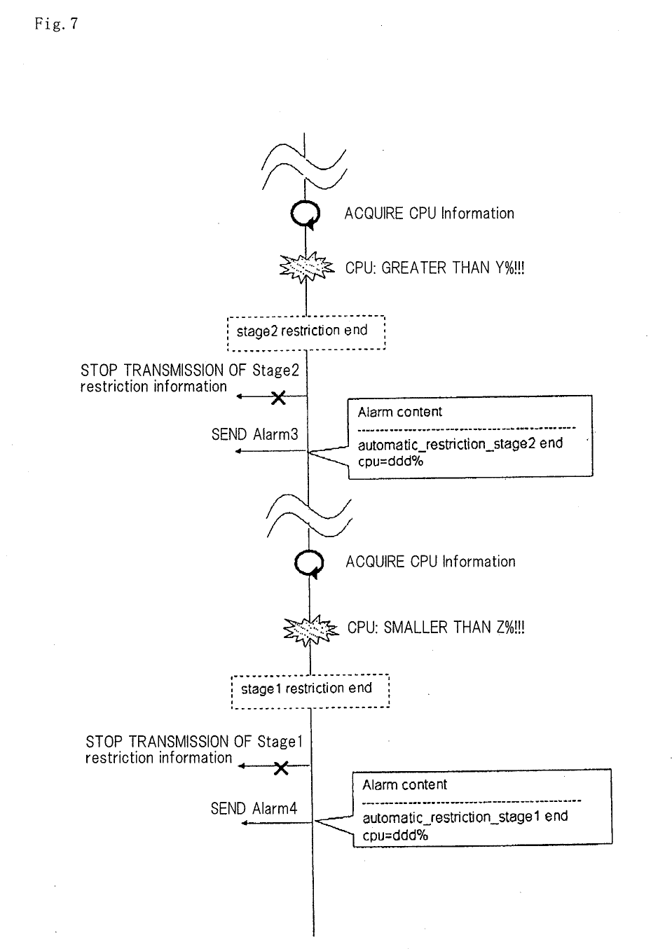

FIG. 7 is a view illustrating an exemplary operation of signal processing server apparatus 11 according to the present example at the time of dissolving the congestion.

When the CPU usage rate falls below Y %, signal processing server apparatus 11 stops the transmission of a STAGE 2 restriction state reporting signal and removes the STAGE 2 restriction. Simultaneously, signal processing server apparatus 11 provides the maintenance person with an alarm (“Alarm3” in FIG. 7) indicating the occurrence of a STAGE 2 restriction removal state.

When the CPU usage rate further lowers and falls below Z %, signal processing server apparatus 11 stops the transmission of a STAGE 1 restriction state reporting signal and removes the STAGE 1 restriction. Simultaneously, signal processing server apparatus 11 provides the maintenance person with an alarm (“Alarm4” in FIG. 7) indicating the occurrence of a STAGE 1 restriction removal state.

While preferred exemplary embodiments of the present invention have been described using specific terms, such description is for illustrative purposes only, and it is to be understood that changes and variations may be made without departing from the spirit or scope of the following claims.

What is claimed is:

1. A communication system comprising:
a signal processing server apparatus that compares a predetermined threshold value with the usage rate of a processor which processes a signal in Internet Protocol communication, and determines, based on the comparison result whether or not congestion has occurred, and gives an instruction for restricting the communication during the occurrence of congestion; and
an opposed station apparatus that restricts Internet Protocol communication with the signal processing server apparatus according to the instructions from the signal processing server apparatus.

2. The communication system according to claim 1, wherein: a plurality of levels of restriction having different content are set, and a threshold value is set for each of the plurality of levels of restriction; and the signal processing server apparatus gives to the opposed station apparatus, an instruction of restriction which level corresponds to a result of comparison between a plurality of the threshold values and the usage rate of the processor.

3. The communication system according to claim 2, wherein:
the signal processing server apparatus is an authentication server that performs authentication for the opposed station apparatus, and there is set a first level restriction which prohibits a request for a new authentication session and a second level restriction which prohibits transmission of all messages, and a first threshold value is set for the first level restriction and a second threshold value that is greater than the first threshold value is set for the second level restriction, and
the signal processing server apparatus gives to the opposed station apparatus, an instruction for instructing the first level restriction when the usage rate of the processor exceeds the first threshold value, and gives an instruction for instructing the second level restriction when the usage rate of the processor exceeds the second threshold value, and gives an instruction for removing the second level restriction and returning to the first level restriction when the usage rate of the processor falls below the second threshold value, and gives an instruction for removing the first level restriction when the usage rate of the processor falls below the first threshold value.

4. The communication system according to claim 1, wherein the threshold value comprises a start threshold value used to determine the start of restriction, and a removal threshold value that is smaller than the start threshold value, used to determine removal of the restriction.

5. A communication restriction method for a signal processing server apparatus that communicates with an opposed station apparatus through Internet Protocol and that processes a signal received from the opposed station apparatus, the method comprising:
measuring the usage rate of a processor that processes the signal;
determining whether or not congestion has occurred, based on a result of comparing the usage rate of the processor with a predetermined threshold value; and
giving an instruction to the opposed station apparatus to restrict the communication during occurrence of congestion.

6. The communication restriction method according to claim 5, wherein:
a plurality of levels of restriction having different contents are set, and a threshold value is set for each of the plurality of levels of restriction; and
the signal processing server apparatus gives to the opposed station apparatus, an instruction for instructing a restriction which level corresponds to a result of comparison between a plurality of the threshold values and the usage rate of the processor.

7. The communication restriction method according to claim 6, wherein:
the signal processing server apparatus is an authentication server that performs authentication for the opposed station apparatus, and there is set a first level restriction which prohibits a request for a new authentication session and a second level restriction which prohibits transmission of all messages, and a first threshold value is set for the first level restriction, and a second threshold value that is greater than the first threshold value is set for the second level restriction; and
the method comprises: starting the first level restriction when the usage rate of the processor exceeds the first threshold value; changing to the second level restriction when the usage rate of the processor exceeds the second threshold value; removing the second level restriction and returning to the first level restriction when the usage rate of the processor falls below the second threshold value; and removing the first level restriction when the usage rate of the processor falls below the first threshold value.

8. The communication restriction method according to claim 5, wherein the threshold value is constituted of a start threshold value used to determine start of restriction, and a removal threshold value that is smaller than the start threshold value, used to determine removal of the restriction.

9. A signal processing server apparatus that communicates with an opposed station apparatus through Internet Protocol and that processes a signal received from the opposed station apparatus, the apparatus comprising:
a processor that processes the signal;
a usage rate measurement section which measures the usage rate of the processor;
a congestion determination section which determines whether or not congestion has occurred, based on a result of comparing the usage rate of the processor with a predetermined threshold value; and
a restriction instruction section which, when the congestion determination section determines that congestion has occurred, gives an instruction to the opposed station apparatus to restrict the communication.

10. The signal processing server apparatus according to claim 9, wherein:
a plurality of levels of restriction having different content are set, and a threshold value is set for each of the plurality of levels of restriction;
the congestion determination section compares a plurality of the threshold values with the usage rate of the processor; and
the restriction instruction section gives to the opposed station apparatus, an instruction for instruct a restriction which level corresponds to a result of comparison by the congestion determination section.

11. The signal processing server apparatus according to claim 10, wherein:
the signal processing server apparatus is an authentication server that performs authentication for the opposed station apparatus, and there is set first level restriction which prohibits a request for a new authentication session and a second level restriction which prohibits transmission of all messages, and a first threshold value is set for the first level restriction and a second threshold value that is greater than the first threshold value is set for the second level restriction; and
the restriction instruction section gives to the opposed station apparatus, an instruction for instruct the first level restriction when the usage rate of the processor exceeds the first threshold value in the comparison by the congestion determination section, and gives an instruction for instruct the second level restriction when the usage rate of the processor exceeds the second threshold value, and gives an instruction for removing the second level restriction and returning to the first level restriction when the usage rate of the processor falls below the second threshold value, and gives an instruction for removing the first level restriction when the usage rate of the processor falls below the first threshold value.

12. The signal processing server apparatus according to claim 9, wherein the threshold value comprises a start threshold value used to determine the start of restriction and a removal threshold value that is smaller than the start threshold value, used to determine removal of the restriction.

13. A signal processing server apparatus that communicates with an opposed station apparatus through Internet Protocol and that processes a signal received from the opposed station apparatus, the apparatus comprising:
a processor that processes the signal;
usage rate measurement means for measuring the usage rate of the processor;
congestion determination means for determining whether or not congestion has occurred, based on a result of comparing the usage rate of the processor with a predetermined threshold value; and
restriction instruction means for, when the congestion determination means determines that congestion has occurred, gives an instruction to the opposed station apparatus to restrict the communication.

14. A recording medium having stored therein a program used to cause a computer that communicates with an opposed station apparatus through Internet Protocol and that processes a signal received from the opposed station apparatus to execute;
a procedure of measuring the usage rate of a processor;
a procedure of determining whether or not congestion has occurred, based on a result of comparing the usage rate of the processor with a predetermined threshold value; and
a procedure of giving instructions to the opposed station apparatus to restrict the communication when it is determined that congestion has occurred.
